(19) United States
(12) Patent Application Publication
(10) Pub. No.: US 2024/0220209 A1
(43) Pub. Date: Jul. 4, 2024

(54) A high-speed and high-accuracy calculation method in inverter and power converter applications and a device operating according to said method

(71) Applicant: Elektra Elektronik Sanayi Ve Ticaret Anonim Sirketi, Istanbul (TR)

(72) Inventor: Veysel Tutku Büyükde?irmenci, Istanbul (TR)

(21) Appl. No.: 17/800,646

(22) PCT Filed: Dec. 30, 2021
(86) PCT No.: PCT/TR2021/051612

§ 371 Date: Feb. 9, 2023

(30) Foreign Application Priority Data
Aug. 6, 2021 (TR) 2021/012485

(51) Int. Cl. G06F 7/72

(52) U.S. Cl. CPC G06F 7/72

(57) ABSTRACT

The invention relates to a polynomial-based method (200) which provides a convergence to the 1/x function which needs to be calculated in order to perform the nonlinear control functions in the grid-connected inverter and power converter applications that require the high-bandwidth digital signal processing and control, and a device (100) which operates according to said method (200).

### TECHNICAL FIELD

The invention relates to a polynomial-based method which provides a convergence to the 1/x function which needs to be calculated in order to perform the nonlinear control functions in the gridgrid-connected inverter and power converterpower converter applications that require the high-speed digital signal processing and high control bandwidth, and a device that operates according to said method.

### PRIOR ART

In recent applications of the theoretical mathematics, often the inverse of an equation or quantity (1/x) needs to be calculated. This requirement exists in every field from today's computers to space technologies. However, due to the difficulty of calculation, high-speed calculation algorithms have been developed depending on the precision. In the state of the art, iterative methods based on Newton-Raphson are often used and the desired value is calculated iteratively using the slope of the 1/x function. Such iterative methods select an initial value when starting the calculation, and iteratively proceed. However, the precision of the calculation result varies depending on how far the starting point is from the output. In some cases, this causes such methods to diverge rather than converge and become unstable. The iterative methods include Householder method and Halley methods. (Wiley-Interscience, 1987).

On the other hand, the desired 1/x value can be calculated by obtaining an approximate polynomial using the Taylor series or approximating by the use of the general polynomial structures. (N. Takagi, 1997, M. Ito, N. Takagi, and S. Yajima, April 1997, M. Ercegovac, T. Lang, J.-M. Muller, and A. Tisserand, July 2000).

In another state of the art, a look-up-table (LUT) can be created depending on the application precision and the approximate 1/x value can be obtained over said LUT (look-up tables). The mentioned method causes very high memory usage depending on the precision. This makes it to be a much more costly solution compared to the iterative or polynomial-based calculation methods.

To this date, the control functions were realized by a microcontroller in many applications. The microcontrollers are the programmable controller chips that contain computing, memory, data processing, and other peripheral units. The ability of standard microcontrollers to be a solution to the present applications has been limited within the scope of the advancing technology and the developing field conditions and requirements. For this reason, companies digitally develop their own application-specific chips (ASICs) or develop the embedded control systems using the field programmable gate arrays (FPGA) chips. In these methods, the programmer makes their own digital design completely, there is no available algorithm for the computation of complex functions such as 1/x, etc. Designers need to develop these algorithms themselves and implement them in their chips. This complicates the design process and extends the product development process.

### SUMMARY OF THE INVENTION

The object of the invention is to perform a polynomial-based method which provides a convergence to the 1/x function which needs to be calculated in order to perform the nonlinear control functions in the gridgrid-connected inverter and power converterpower converter applications which require the high-bandwidth digital signal processing and control.

On the other hand, in the real-time embedded control systems the method of the invention; may be employed with ease, high-accuracy and high-efficiency on a digital signal processor (DSP) and/or application specific chips (ASIC) and/or field programmable gate arrays (FPGA) the purpose of which is to measure or filter the analog signals.

### DESCRIPTION OF FIGURES

FIG. 1 is a representative view of the block diagram of the high-speed 1/x function calculation unit developed for the inverter and power converter applications.

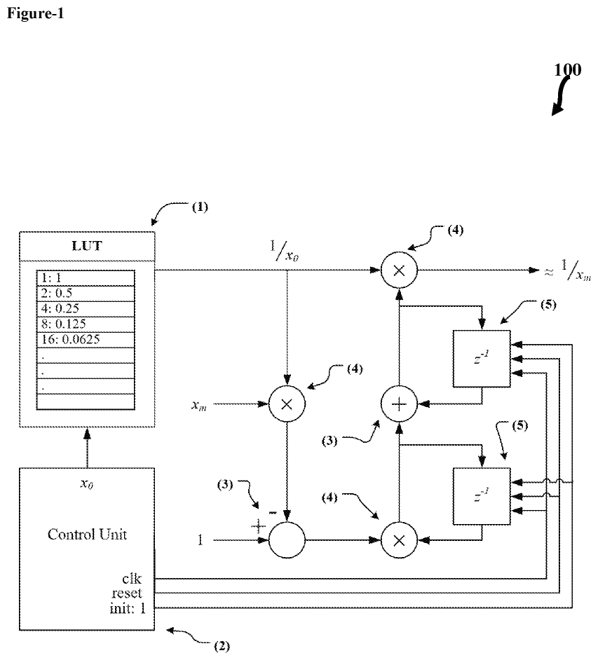

FIG. 2 is a general view of the flow diagram of the method of the invention.

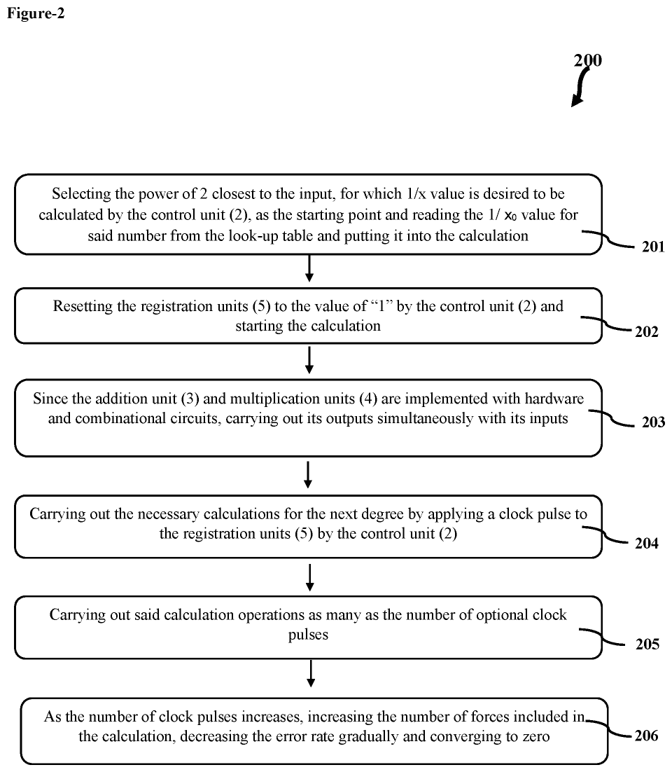

### DESCRIPTION OF THE REFERENCES IN THE DRAWINGS

The numbers in the drawings are provided below in order to provide a better understanding of the invention:
100. Device
1. Look up table unit (LUT)
2. Control unit
3. Addition unit
4. Multiplication unit
5. Register unit
200. Method

### DETAILED DESCRIPTION OF THE INVENTION

The invention relates to a polynomial-based method (200) which provides a convergence to the 1/x function which needs to be calculated in order to perform the nonlinear control functions in the gridgrid-connected inverter and power converterpower converter applications that require the high-bandwidth digital signal processing and the control technique, and a device (100) which operates according to said method (200).

The device (100) of the invention; comprises at least one look-up table unit (LUT) (1), at least one control unit (2), at least one addition unit (3), at least one multiplication unit (4) and at least one register unit (5).

The device (100) of the invention; can calculate the 1/x function with high-accuracy and high-speed by using the register units (5) which keep the records of the data such as the look-up table unit (1), the control unit (2), the addition unit (3) and the multiplication unit (4). Said register units (5) register the data in its inputs at each clock pulse (clk) sent by the control unit (2) and apply said recorded data to its outputs. These register units (5) can be reset to the value which is desired by the control unit (2) (for the method (200), this value equals to init: 1). For said resetting, there is one resetting input and one value input to be taken in the resetting.

The 1/x function is often applied for the DC bus voltage. These inverters and power converterpower converters calculate the modulation index depending on the information resulting from this operation and apply pulse width modulated control signals to power semiconductor devices. In these applications, the 1/x operation is realized based on the look-up table unit (LUT) (1) and some other approximate calculation methods in the source library of the microcontroller used.

The device (100) of the invention operates according to the steps of the below method (200).
Selecting the power of 2 closest to the input, for which 1/x value is desired to be calculated by the control unit (2), as the starting point and reading the 1/x₀ value for said number from the look-up table and putting (201) it into the calculation,
Resetting the register units (5) to the value of “1” by the control unit (2) and starting (202) the calculation,
Since the addition unit (3) and multiplication units (4) are implemented with hardware and combinational circuits, carrying out (203) its outputs simultaneously with its inputs,
Carrying out (204) the necessary calculations for the next degree by applying a clock pulse to the register units (5) by the control unit (2),
Carrying out (205) said calculation operations as many as the number of optional clock pulses,
As the number of clock pulses increases, increasing the number of forces included in the calculation, decreasing the error rate gradually and converging (206) to zero.

The method (200) of the invention has no risk of divergence compared to the iterative methods. Therefore, it has a general convergent characteristic.

The invention has an accuracy as many as the number of rising edges of the applied clock frequency. Each clock frequency corresponds to one degree of the polynomial which is the Taylor series expansion. In one preferred embodiment, for example with 4 hour rising edges, an approximate calculation can be made up to the 4th degree, while with 16 rising edges, precision up to 16th degree can be obtained. The method (200) of the invention provides superiority over other methods in applications in which the precise calculations within a very low number of rising edges of the clock in the control loops that need to be fast are required and since the same calculation units are used on the chip repeatedly, it uses less chip area compared to competing methods, thanks to its recursive structure.

The invention is based on the approximation of the f(x)=1/x function around the x₀ point over the Taylor Series polynomial. Taylor series is shown by the below equation;

$$f ( x ) = {\sum }_{n = 0}^{=} \frac{{f}^{( n )} ( {x}_{0} )}{n !} {( x - {x}_{0} )}^{n} \qquad ( 1 )$$

Wherein;
n!: is the n factorial
x₀: is the starting point to be approximated
f⁽ⁿ⁾(x₀): is the n degree derivative of the function at the starting point to be approximated

When the 1/x function is linearized around the a point using the Taylor Series, the value 1/xₘ can be calculated as below:

$$f ( {x}_{m} ) = 1 / {x}_{m} = {\sum }_{n = 0}^{=} \frac{{( - 1 )}^{( n )}}{{x}_{0}^{n}} {( {x}_{m} - {x}_{0} )}^{n} \qquad ( 2 )$$

When the system is considered as a polynomial herein;

$$f ( {x}_{m} ) = 1 / {x}_{m} = \frac{1}{{x}_{0}} - \frac{1}{{x}_{0}^{2}} ( {x}_{m} - {x}_{0} ) + \frac{1}{{x}_{0}^{3}} {( {x}_{m} - {x}_{0} )}^{2} - \frac{1}{{x}_{0}^{4}} {( {x}_{m} - {x}_{0} )}^{3} \text{?} \qquad ( 3 )$$

$$\text{?} \text{indicates text missing or illegible when filed}$$

when said polynomial equation in the table (3) is calculated for infinite degrees, it gives exactly the accurate result. However, in case of starting from a point close enough to the reverse point which is searched, the “error rate” decreases below the acceptable level in N calculations.

$$f ( {x}_{m} ) = 1 / {x}_{m} \approx \frac{1}{{x}_{0}} - \frac{1}{{x}_{0}^{2}} ( {x}_{m} - {x}_{0} ) + \frac{1}{{x}_{0}^{3}} {( {x}_{m} - {x}_{0} )}^{2} - … + \frac{1}{{x}_{0}^{N + 1}} {( {x}_{m} - \text{?} )}^{N} \qquad ( 4 )$$

$$\text{?} \text{indicates text missing or illegible when filed}$$

Wherein, for 32-bit fixed-point mathematical operations, especially inclined to digital design, a look-up table unit (LUT) (1) is created by selecting x₀ values as 1, 2, 4, 8, 16, 32 . . . Table-1 which is created for said x₀ values is given below. In this way, operations are repeated in N steps by selecting a small starting point closest to the value the inverse of which is desired to be calculated. Therefore, each operation is multiplied by a constant multiple of the previous result.

TABLE 1
The look-up table unit (LUT) created for the x₀ values

1: 1
2: 0.5
4: 0.25
8: 0.125
16: 0.0625
.
.
.

Herein the control unit (2) resets the register unit (5) to the value of “1” and starts the calculation by pulling the power of 2 closest to the input value from the look-up table as the starting point. An upper degree of the polynomial shown in table (4) is calculated with each clock pulse and added to the result recursively. When the operations are repeated as many as “N” clock pulses, the equation given in the table (4) is calculated. The user herein may determine the number of clock pulses to calculate the degree as needed by determining the acceptable error rate.

### INDUSTRIAL APPLICABILITY OF THE INVENTION

The invention is a polynomial-based method (200) which provides a convergence to the 1/x function which needs to be calculated in order to perform the nonlinear control functions in the grid-connected inverter and power converter applications that require the high-bandwidth digital signal processing and control, a device (100) which operates according to said method (200), wherein it is applied industrially.

The invention is not limited to the foregoing exemplary embodiments, and one person skilled in the art may easily reveal the different embodiments of the invention. These should be considered within the scope of protection of the invention claimed in the claims.

1. A device (100) for providing a convergence to the 1/x function which needs to be calculated in order to perform the nonlinear control functions in the grid-connected inverter and power converter applications which require the high-bandwidth digital signal processing and the control technique,
characterized in that it comprises at least one look-up table unit (LUT) (1), at least one control unit (2), at least one addition unit (3), at least one multiplication unit (4) and at least one register unit (5) which records the data in its inputs in each clock pulse (clk) sent by the control unit (2) and applies the recorded data to its outputs and which can be reset to the desired value by the control unit (2).

2. A method (200) for providing a convergence to the 1/x function which needs to be calculated in order to perform the nonlinear control functions in the grid-connected inverter and power converter applications which require the high-bandwidth digital signal processing and the control technique, characterized by the following steps:
Selecting the power of 2 closest to the input, for which 1/x value is desired to be calculated by the control unit (2), as the starting point and reading the 1/x0 value for said number from the look-up table and putting (201) it into the calculation,
Resetting the register units (5) to the value of “1” by the control unit (2) and starting (202) the calculation,
Since the addition unit (3) and multiplication units (4) are implemented with hardware and combinational circuits, carrying out (203) its outputs simultaneously with its inputs,
Carrying out (204) the necessary calculations for the next degree by applying a clock pulse to the register units (5) by the control unit (2), Carrying out (205) said calculation operations as many as the number of optional clock pulses,
As the number of clock pulses increases, increasing the number of forces included in the calculation, decreasing the error rate gradually and converging (206) to zero.
